(19) United States
(12) Patent Application Publication
(10) Pub. No.: US 2024/0313681 A1
(43) Pub. Date: Sep. 19, 2024

(54) WIPER CONTROLLER

(71) Applicant: DENSO CORPORATION, Kariya-city (JP)

(72) Inventors: HIROTO OSAKABE, Kariya-city (JP); RYUMA MITO, Kariya-city (JP)

(21) Appl. No.: 18/436,595

(22) Filed: Feb. 8, 2024

(30) Foreign Application Priority Data
Mar. 13, 2023 (JP) 2023-038718

(51) Int. Cl. H02P 21/16; B60S 1/08; H02P 21/22

(52) U.S. Cl. CPC H02P 21/16; B60S 1/08; H02P 21/22

(57) ABSTRACT

A wiper controller includes a driver and a controller. The driver includes a three-phase bridge circuit having switching elements connecting a positive electrode and a negative electrode of a direct current power supply to terminals of a motor. The controller switches the switching elements between an on-state and an off-state. The controller controls electrical conduction of the motor through vector control by switching the switching elements between the on-state and the off-state to limit a value of a q-axis current to zero, in response to that a detection voltage value of the direct current power supply exceeds a preset overvoltage determination value.

### CROSS REFERENCE TO RELATED APPLICATION

This application is based on Japanese Patent Application No. 2023-038718 filed on Mar. 13, 2023, the disclosure of which is incorporated herein by reference.

### TECHNICAL FIELD

The present disclosure relates to a wiper controller.

### BACKGROUND

A wiper controller may control a wiper driven by a brushed direct current (DC) motor, and the wiper controller equipped with the brushed DC motor may inhibit damage to a circuit included in the wiper controller in a case where a surge occurs in the wiper controller.

### SUMMARY

The present disclosure describes a wiper controller for controlling a wiper including a motor for driving a wiper blade, and further describes the wiper controller having a driver, a controller, and a voltage detector.

### BRIEF DESCRIPTION OF DRAWINGS

Objects, features and advantages of the present disclosure will become more apparent from the following detailed description made with reference to the accompanying drawings. In the drawings:

FIG. 1 illustrates a configuration of a drive system according to a first embodiment;

FIG. 2 illustrates a configuration of a motor;

FIG. 3 is a flowchart that illustrates a surge handling process according to the first embodiment;

FIG. 4 is a timing chart that illustrates a motor control method according to the first embodiment;

FIG. 5 is a flowchart that illustrates a surge handling process according to a second embodiment;

FIG. 6 is a timing chart showing a motor control method according to the second embodiment;

FIG. 7 is a flowchart that illustrates a surge handling process according to a third embodiment; and

FIG. 8 is a timing chart that illustrates a motor control method according to the third embodiment.

### DETAILED DESCRIPTION

The inventors of the present application found out that a circuit included in a wiper controller driven by a three-phase AC motor may be damaged in a case where a surge occurs in the wiper controller.

According to a first aspect of the present disclosure, a wiper controller controls a wiper having a motor for driving a wiper blade. The wiper controller includes a driver, a controller and a voltage detector.

The driver includes a three-phase bridge circuit having multiple switching elements connecting the positive and negative electrodes of a direct current power supply and multiple terminals of a motor. The driver supplies a three-phase alternating current through the three-phase bridge circuit to the motor.

The controller controls the motor by switching each of the switching elements of the driver between the on-state and the off-state. The voltage detector detects the voltage value of the direct current power supply as the detection voltage value.

The controller includes a q-axis current conductor. When the detection voltage value exceeds the preset overvoltage determination value, the q-axis current conductor controls the electrical conduction of the motor by switching each of the switching elements between the on-state and the off-state so that a value of the q-axis current becomes zero by using the vector control.

The above-mentioned wiper controller controls electrical conduction to the motor so that the value of the q-axis current becomes zero when a surge occurs and the voltage value of the DC power supply exceeds the overvoltage determination value. Therefore, an overcurrent caused by a surge can flow through the motor without rotating the motor. As a result, the above-mentioned wiper controller can inhibit a situation in which a voltage exceeding the element breakdown voltage is applied to the elements of the circuit included in the wiper controller when a surge occurs, and the wiper controller can inhibit a damage to the circuit included in the wiper controller. Therefore, it is possible to enhance the reliability to the surge. Since the above-mentioned wiper controller does not rotate the motor when the surge occurs, it is possible to inhibit a situation in which the operation of the wiper blade suddenly starts during the running of the vehicle and blocks a driver's view.

According to a second aspect of the present disclosure, a wiper controller controls a wiper having a motor for driving a wiper blade. The wiper controller includes a driver, a controller and a voltage detector.

The driver includes a three-phase bridge circuit, and supplies a three-phase alternating current to a motor through the three-phase bridge circuit. The three-phase bridge circuit has multiple high-side switching elements and multiple low-side switching elements. The high-side switching elements are connected between the terminals of the motor and the positive electrode of the direct current power supply. The low-side switching elements are connected between the terminals of the direct current power supply and the negative electrode of the direct current power supply.

The controller controls the motor by switching the high-side switching elements and the low-side switching elements of the driver between the on-state and the off-state.

The controller includes a fixing electrical conductor. The fixing electrical conductor controls the electrical conduction of the motor by fixing the target high-side switching element to the on-state in a case where the detection voltage value exceeds the preset overvoltage determination value, and then sequentially switching the first target low-side switching element and the second target low-side switching element between the on-state and the off-state so that one of the first target low-side switching element and the second target low-side switching element is turned to the on-state.

One of the high-side switching elements is set as the target high-side switching element that is connected to one of the terminals of the motor. Two of the low-side switching elements are set as a first target low-side switching element and a second target low-side switching element, both of which are connected to other two of the terminals of the motor.

The above-mentioned wiper controller can allow the overcurrent caused by the surge to flow through the motor by alternately repeating the forward rotation and reverse rotation of the motor, in a case where the surge occurs and then the voltage value of the DC power supply exceeds the overvoltage determination value. As a result, the above-mentioned wiper controller can inhibit a situation in which a voltage exceeding the element breakdown voltage is applied to the elements of the circuit included in the wiper controller when a surge occurs, and the wiper controller can inhibit a damage to the circuit included in the wiper controller. Therefore, it is possible to enhance the reliability to the surge. The above-mentioned wiper controller can limit the movement range of the wiper blade to the necessary minimum by alternately repeating the forward rotation and reverse rotation of the motor when the surge occurs. Therefore, it is possible to inhibit the situation in which the operation of the wiper blade suddenly starts and blocks a vehicle driver's field of view during the running of the vehicle.

### FIRST EMBODIMENT

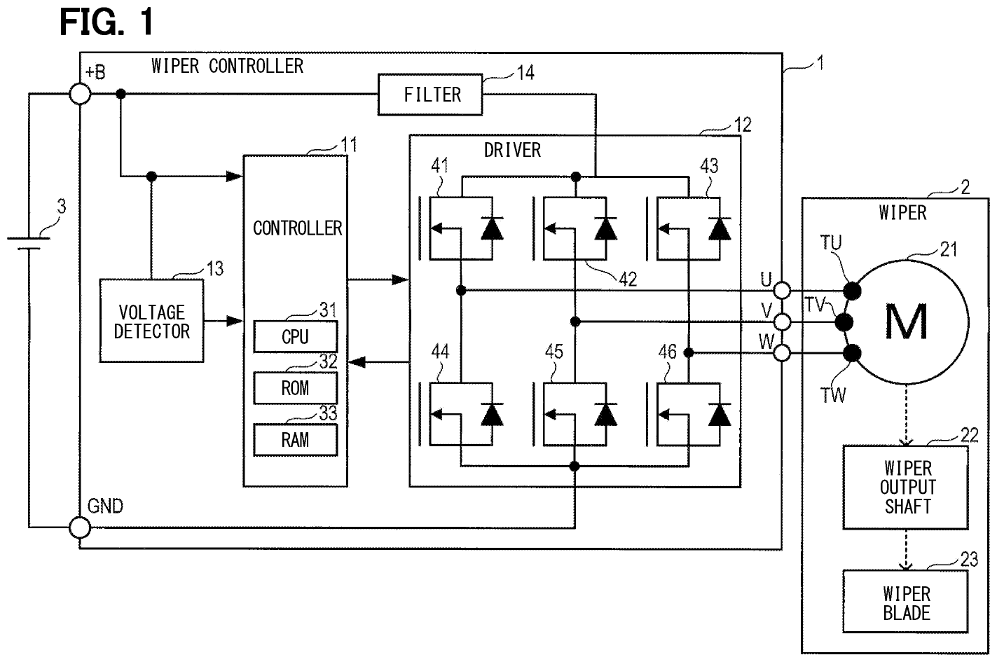

The following describes a first embodiment of the present disclosure with reference to the drawings. As illustrated in FIG. 1, a wiper controller 1 according to the present embodiment controls a wiper 2 that wipes a windshield glass of a vehicle.

The wiper 2 includes a motor 21, a wiper output shaft 22, and a wiper blade 23. The motor 21 is a three-phase alternating current (AC) motor. The rotational driving force of the motor 21 is transmitted to the wiper output shaft 22 via a speed reducer (not shown). The rotational driving force of the wiper output shaft 22 is transmitted to the wiper blade 23 via a link mechanism (not shown). Thereby, the wiper blade 23 reciprocates left and right on the windshield glass.

The wiper controller 1 includes a controller 11, a driver 12, a voltage detector 13, and a filter 14. The controller 11 is an electronic control device mainly composed of a microcomputer including, for example, a CPU 31, a ROM 32, and a RAM 33. Various functions of the microcomputer are implemented by the CPU 31 executing programs stored in a non-transient physical recording medium. In this example, the ROM 32 corresponds to the non-transient physical storage medium in which the programs are stored. By executing the program, the method corresponding to the program is performed. A part or all of the functions to be executed by the CPU 31 may be configured in hardware by one or multiple ICs or the like. The number of microcomputers included in the controller 11 may be one or more.

The driver 12 is a circuit that receives power supply from a battery 3 and applies a battery voltage VB between corresponding phases U, V W of the motor (between U-phase and V-phase, between V-phase and W-phase, and between W-phase and U-phase) to execute electrical conduction of a stator coil to rotate the motor 21.

The stator coils of corresponding phases U, V, and W of the motor 21 are in Y-winding connection. The driver 12 is connected to three terminals TU, TV, and TW on the opposite side of the Y-winding connection. The driver 12 includes a three-phase full bridge circuit having six switching elements 41, 42, 43, 44, 45 and 46.

The switching elements 41, 42, and 43 are arranged between the positive electrode of the battery 3 and the phases U, V and W of the motor 21, and are referred to as high-side switches. The switching elements 44, 45, and 46 are arranged between the negative electrode of the battery 3 and the phases U, V and W of the motor 21, and are referred to as low-side switches.

Therefore, in the driver 12, by turning on one high-side switch and one low-side switch whose phases are different from each other, the battery voltage VB is applied between corresponding phases U, V, and W of the motor 21.

By switching the switching element that turns on, it is possible to switch the terminals TU, TV, TW to which the battery voltage VB is applied, and to switch the direction in which the battery voltage VB is applied. By controlling the on-time of the switching element, it is possible to control the current flowing through the motor 21.

The controller 11 controls the switching elements 41 to 46 inside the driver 12 to turn them on or off, thereby allowing current to flow through the stator coils of each phase U, V, W of the motor 21 and rotating the motor 21.

The voltage detector 13 detects the battery voltage VB and outputs a voltage detection signal to the controller 11. The voltage detection signal indicates a detection result. The filter 14 is disposed on a current path between the battery 3 and the high-side switches, in other words, the switching elements 41 to 43 of the driver 12, and removes noise generated by switching in the driver 12.

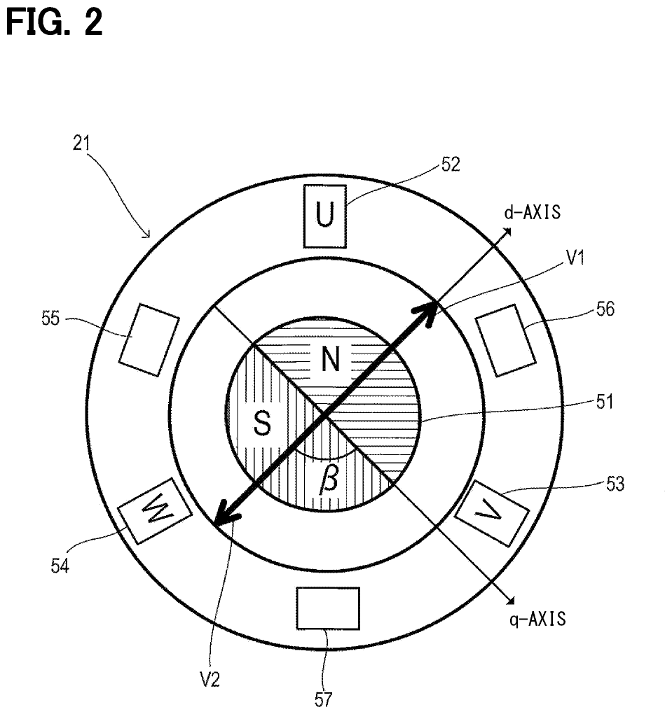

As shown in FIG. 2, the motor 21 includes a rotor 51, three stators 52, 53, 54, and three Hall ICs 55, 56, 57. The rotor 51 supports the permanent magnets in a rotatable manner. The stators 52, 53, and 54 are arranged around the rotor 51 at equal angular intervals. The stators 52, 53, and 54 are wound with U, V, and W-phase windings, respectively.

The Hall ICs 55, 56, and 57 are integrated circuits incorporating Hall elements, and detect the magnetic poles of the permanent magnet that rotates together with the rotor 51, and output detection signals having a signal level corresponding to the polarity of the magnetic poles. The Hall ICs 55, 56, and 57 are arranged around the rotor 51 at equal angular intervals.

The controller 11 drives the motor 21 through vector control. The controller 11 includes a current command value generator, a three-phase to two-phase converter, a current controller, a two-phase to three-phase converter, and a Pulse Width Modulation (PWM) modulator, each of which is a functional block executed by the CPU 31 that executes a program stored in the ROM 32.

The current command value generator generates a d-axis current command value and a q-axis current value in a d-q axis coordinate system, as command values required for driving the wiper blade 23. The d-q coordinate system is a rotating coordinate system where the flux direction of the permanent magnet in the rotor 51 is defined as the d-axis, and the direction orthogonal to the d-axis that generates torque on the rotor 51 is defined as the q-axis.

The three-phase to two-phase converter detects the current flowing through each phase U, V, W of the motor 21 from the driver 12 (hereinafter referred to as a three-phase current), and based on the detection signals from Hall ICs 55 to 57, converts the three-phase current into the d-axis current and the q-axis current. The d-axis current is a component of the current flowing through the motor 21 that generates a rotating magnetic field. The q-axis current is a component of the current flowing through the motor 21 that causes the motor 21 to generate torque.

The current controller calculates the d-axis voltage command value and q-axis voltage command value based on the deviation between the d-axis current and q-axis current converted by the three-phase to two-phase converter, and the d-axis current command value and q-axis current command value generated by the current command generator. These voltage command values are then output to the two-phase to three-phase converter. The d-axis voltage command value is a voltage command value required to control the d-axis current to the d-axis current command value. The q-axis voltage command value is a voltage command value required to control the q-axis current to the q-axis current command value.

The two-phase to three-phase converter generates three-phase voltage command values by transforming the d-axis voltage command value and q-axis voltage command value calculated by the current controller through coordinate conversion. These voltage command values are then output to the PWM modulator. The PWM modulator controls the actual voltage output to the terminals TU, TV, and TW of the phases U, V, W of the motor 21, according to the three-phase voltage command values. As a result, the PWM modulator outputs control signals to the switching elements 41 to 46 included in the driver 12, in order to execute PWM control of the voltage of each phase U, V, W. The control signals switch the on and off-states of the switching elements 41 to 46 to control the power supplied to each phase U, V, W of the motor 21.

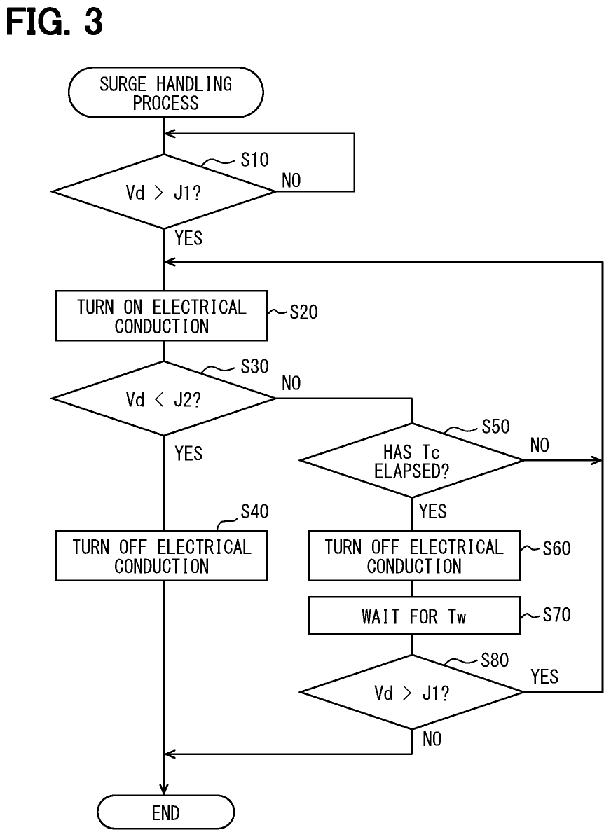

The following describes the procedure of a surge handling process executed by the controller 11. The surge handling process is a process that is repeatedly executed while the wiper controller 1 is in operation. When the surge handling process is executed, the CPU 31 of the controller 11 determines at S10 whether the detection voltage value (referred to as a detection voltage value Vd) detected by the voltage detector 13 exceeds a preset overvoltage determination value J1 as shown in FIG. 3. If the detection voltage value Vd is equal to or less than the overvoltage determination value J1, the CPU 31 watches and waits until the detection voltage value Vd exceeds the overvoltage determination value J1 by repeating S10.

When the detection voltage value Vd exceeds the overvoltage determination value J1, the CPU 31 executes electrical conduction of the motor 21 at a current advance angle at which the q-axis current becomes zero (that is, a current advance angle fixed at 90°) at S20. Specifically, CPU 31, as shown in FIG. 2 with a vector V1 or a vector V2, fixes the current advance angle ß to 90 degrees. Therefore, the current vector indicating the d-axis current command value and the q-axis current command value in the d-q coordinate system is made to be orthogonal to the q-axis. As a result, the high-side switch is determined from the switching elements 41, 42, and 43 to be turned on in accordance with the rotation angle of the motor 21, so that the motor 21 does not rotate. Similarly, the low-side switch is determined from the switching elements 44, 45, and 46 to be turned on, and the electrical conduction of the motor 21 is performed.

When the process at S20 is completed, as shown in FIG. 3, the CPU 31 determines whether the detection voltage value Vd is smaller than the normality determination value J2 set to be smaller than the overvoltage determination value J1 at S30. When the detection voltage value Vd is smaller than the normality determination value J2, the CPU 31 stops the electrical conduction of the motor 21 and completes the surge handling process at S40.

On the other hand, if the detection voltage value Vd is equal to or higher than the normality determination value J2, the CPU 31 determines at S40 whether a preset duration Tc has elapsed since the start of electrical conduction of the motor 21 in S20.

If the duration Tc has not elapsed since the start of electrical conduction of the motor 21, the CPU 31 shifts the process to S20. On the other hand, if the duration Tc has elapsed since the start of electrical conduction of the motor 21, the CPU 31 stops the electrical conduction of the motor 21 at S60.

The CPU 31 waits for a preset waiting time Tw at S70. The CPU 31 determines whether the detection voltage value Vd exceeds the overvoltage determination value J1 at S80. If the detection voltage value Vd exceeds the overvoltage determination value J1, the CPU 31 shifts the process to S20. On the other hand, if the detection voltage value Vd is smaller than or equal to the overvoltage determination value J1, the CPU 31 completes the surge handling process.

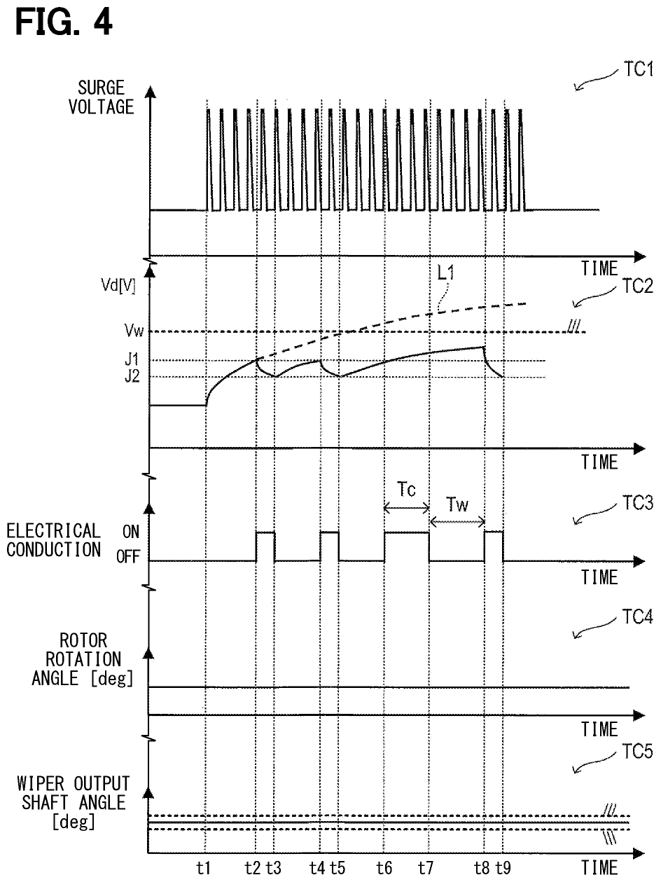

The following describes the control of the motor 21 through the controller 11. A timing chart TC1 in FIG. 4 shows a change in a surge voltage over time. A timing chart TC2 shows a change in the detection voltage value Vd over time. A timing chart TC3 shows a change in turning on or off the electrical conduction of the motor 21 over time. A timing chart TC4 shows a change in the rotation angle of the rotor 51 over time. A timing chart TC5 shows a change in the angle of the wiper output shaft 22 over time.

When the detection voltage value Vd exceeds the overvoltage determination value J1 at time t2 due to the occurrence of a surge at time t1, the electrical conduction of the motor 21 is started. As a result, the detection voltage value Vd decreases. Even though the electrical conduction of the motor 21 is started, the rotational angle of the rotor 51 does not change. Therefore, the angle of the wiper output shaft 22 does not change.

Then, when the detection voltage value Vd becomes smaller than the normality determination value J2 at time t3, the electrical conduction of the motor 21 is stopped. However, the detection voltage value Vd rises through the stop of electrical conduction of the motor 21 since the surge continues.

When the detection voltage value Vd exceeds the overvoltage determination value J1 at time t4, the electrical conduction of the motor 21 is started. As a result, the detection voltage value Vd decreases. When the detection voltage value Vd becomes smaller than the normality determination value J2 at time t5, the electrical conduction of the motor 21 is stopped. Even though the motor 21 is electrically conducted from time t4 to time t5, since the rotational angle of the rotor 51 does not change, the angle of the wiper output shaft 22 does not change either.

When the detection voltage value Vd exceeds the overvoltage determination value J1 at time t6, the electrical conduction of the motor 21 is started. Since the detection voltage value Vd does not decrease but increases, the electrical conduction of the motor 21 is stopped at time t7. The time t7 is at a time point where the duration Tc has elapsed from the time t6.

Since the electrical conduction of the motor 21 is started since the detection voltage value Vd exceeds the overvoltage determination value J1 at time t8. The time t8 is a time point where the duration Tw has elapsed from the time t7. As a result, the detection voltage value Vd decreases. When the detection voltage value Vd becomes smaller than the normality determination value J2 at time t9, the electrical conduction of the motor 21 is stopped.

Even though the surge generated at the time t1 has continued until the time t9, it is possible that the detection voltage value Vd does not exceed the element breakdown voltage Vw. When the electrical conduction of the motor 21 is not performed, the detection voltage value Vd exceeds the element breakdown voltage Vw through the occurrence of the surge as illustrated by a broken line L1 of the timing chart TC2.

The wiper controller 1 controls the wiper 2 including the motor 21 for driving the wiper blade 23. The wiper controller 1 includes the driver 12, the controller 11, and the voltage detector 13.

The driver 12 supplies a three-phase AC current to the motor 21 by means of a three-phase bridge circuit having the switching elements 41, 42, 43, 44, 45, 46 that connect the positive and negative electrodes of the battery 3 and the terminals TU, TV, TW of the motor 21.

The controller 11 controls the motor 21 by switching each of the switching elements 41 to 46 of the driver 12 between the on-state and the off-state. The voltage detector 13 detects the voltage value of the battery 3 as the detection voltage value Vd.

When the detection voltage value Vd exceeds the preset overvoltage determination value J1, the controller 11 controls the electrical conduction of the motor 21 by switching each of the switching elements 41 to 46 on and off so that the q-axis current becomes zero by using the vector control.

The wiper controller 1 controls the electrical conduction of the motor 21 so that the q-axis current becomes zero when a surge occurs and the voltage value of the battery 3 exceeds the overvoltage determination value. Therefore, an overcurrent caused by a surge can flow through the motor 21 without rotating the motor 21. As a result, the wiper controller 1 can inhibit a situation in which a voltage exceeding the element breakdown voltage is applied to the elements of the circuit included in the wiper controller 1 when a surge occurs, and the wiper controller can inhibit a damage to the circuit included in the wiper controller 1. Therefore, it is possible to enhance the reliability to the surge. Since the wiper controller 1 does not rotate the motor 21 when the surge occurs, it is possible to inhibit a situation in which the operation of the wiper blade 23 suddenly starts during the running of the vehicle and blocks a driver's view.

On the other hand, if the preset duration Tc has elapsed since the start of electrical conduction of the motor 21, the controller 11 stops the electrical conduction of the motor 21. As a result, the wiper controller 1 can further enhance reliability against the surge by suppressing the heating of the switching elements 41 to 46 caused by the electrical conduction of the motor 21 and preventing damage to the switching elements 41 to 46.

In the above-mentioned embodiment, the battery 3 corresponds to a direct current (DC) power supply, and S10 to S80 correspond to a process executed by a q-axis current conductor.

### SECOND EMBODIMENT

The following describes a second embodiment of the present disclosure with reference to the drawings. In the second embodiment, portions different from those of the first embodiment will be described. Common configurations are denoted by the same reference numerals.

The wiper controller 1 according to the second embodiment is different from the wiper controller 1 according to the first embodiment such that the surge handing process is modified in the second embodiment. The following describes the procedure of the surge handing process according the second embodiment.

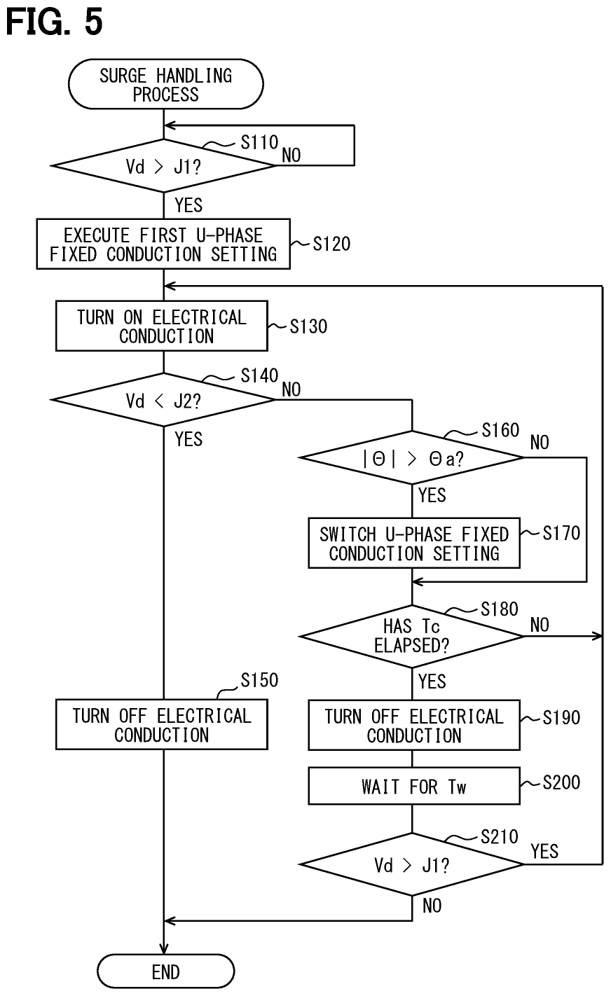

When the surge handling process according to the second embodiment is executed, the CPU 31 of the controller 11 determines at S110 whether the detection voltage value Vd exceeds a preset overvoltage determination value J1 as shown in FIG. 5. If the detection voltage value Vd is equal to or less than the overvoltage determination value J1, the CPU 31 watches and waits until the detection voltage value Vd exceeds the overvoltage determination value J1 by repeating S110.

Subsequently, when the detection voltage value Vd exceeds the overvoltage determination value J1, the CPU 31 executes first U-phase fixed conduction setting. In the first U-phase fixed conduction setting, the switching elements 41, 45 are turned to the on-state, and the switching elements 42, 43, 44, 46 are turned to the off-state. In the after-mentioned second U-phase fixed conduction setting, the switching elements 41, 46 are turned to the on-state, and the switching elements 42, 43, 44, 45 are turned to the off-state. In the following, both of the first U-phase fixed conduction setting and the second U-phase fixed conduction setting are referred to U-phase fixed conduction setting.

The CPU 31 executes electrical conduction of the motor 21 at S130. As a result, the current flows between the U-phase and the V-phase. The CPU 31 determines whether the detection voltage value Vd is less than the normality determination value J2 at S140. When the detection voltage value Vd is smaller than the normality determination value J2, the CPU 31 stops the electrical conduction of the motor 21 and completes the surge handling process at S150.

If the detection voltage value Vd is equal to or higher than the normality determination value J2, the CPU 31 determines at S160 whether or not the absolute value of the angle Θ of the wiper output shaft 22 exceeds a preset rotation limit angle Θa. If the absolute value of the angle Θ is less than or equal to the rotation limit angle Θa, the CPU 31 shifts the process to S180.

If the absolute value of the angle Θ exceeds the rotation limit angle Θa, the CPU 31 switches the U-phase fixed conduction setting at S170, and shifts the process to S180. When the present U-phase fixed conduction setting is the first U-phase fixed conduction setting, the CPU 31 executes the second U-phase fixed conduction setting. When the present U-phase fixed conduction setting is the second U-phase fixed conduction setting, the CPU 31 executes the first U-phase fixed conduction setting.

When the process is shifted to S180, the CPU 31 determines at S130 whether a preset duration Tc has elapsed since the start of electrical conduction of the motor 21. If the duration Tc has not elapsed since the start of electrical conduction of the motor 21, the CPU 31 shifts the process to S130. On the other hand, if the duration Tc has elapsed since the start of electrical conduction of the motor 21, the CPU 31 stops the electrical conduction of the motor 21 at S190.

The CPU 31 waits for a preset waiting time Tw at S200. The CPU 31 determines whether the detection voltage value Vd exceeds the overvoltage determination value J1 at S210. If the detection voltage value Vd exceeds the overvoltage determination value J1, the CPU 31 shifts the process to S130. On the other hand, if the detection voltage value Vd is smaller than or equal to the overvoltage determination value J1, the CPU 31 completes the surge handling process.

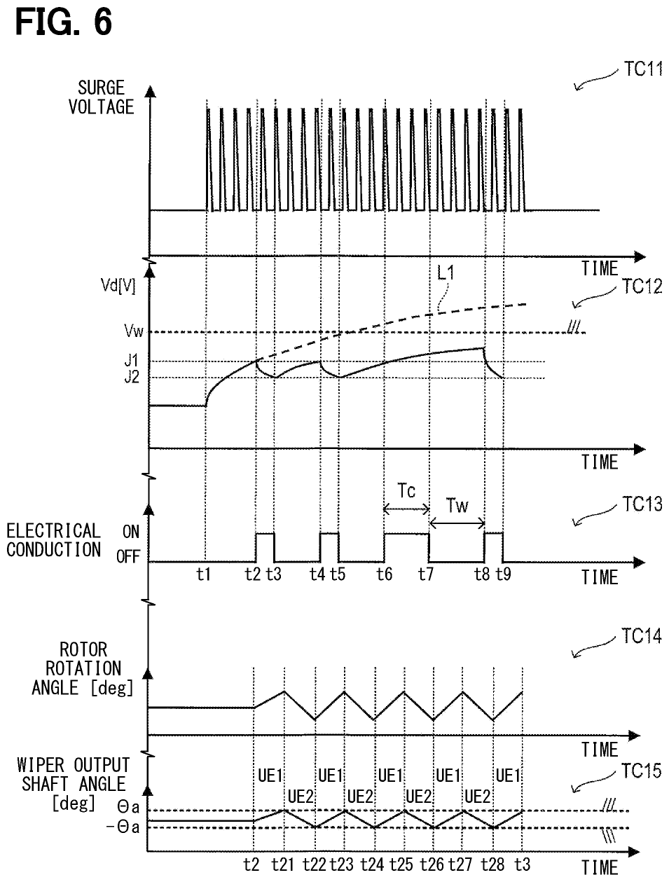

The following describes the control of the motor 21 through the controller 11. A timing chart TC11 in FIG. 6 shows a change in a surge voltage over time. A timing chart TC12 shows a change in the detection voltage value Vd over time. A timing chart TC13 shows a change in turning on or off the electrical conduction of the motor 21 over time. A timing chart TC14 shows a change in the rotation angle of the rotor 51 over time. A timing chart TC15 shows a change in the angle of the wiper output shaft 22 over time.

The timing charts TC11, TC12, and TC13 are the same as the timing charts TC1, TC2, and TC3, respectively. Therefore, the description of the timing charts TC11, TC12, and TC13 will be omitted.

The timing chart TC14 shows a change in the rotation angle of the rotor 51 over time from the time t2 to the time t3 during which the electrical conduction of the motor 21 is executed. The timing chart TC15 shows a change in the angle of the wiper output shaft 22 over time from time t2 to time t3.

As shown in FIG. 6, from time t2 when the electrical conduction of the motor 21 is started, the rotation angle of the rotor 51 gradually increases, and the angle Θ of the wiper output shaft 22 gradually increases accordingly. This is because the current flows between the U-phase and the V-phase due to the first U-phase fixed conduction setting being executed.

Subsequently, when the angle Θ becomes larger than the rotation limit angle Θa at the time t21, the rotation angle of the rotor 51 gradually decreases, and the angle Θ of the wiper output shaft 22 gradually decreases accordingly. This is because the current flows between the U-phase and the W-phase due to the second U-phase fixed conduction setting being executed at the time t21.

Subsequently, when the angle Θ becomes smaller than the rotation limit angle Θa at the time t22, the rotation angle of the rotor 51 gradually increases, and the angle Θ of the wiper output shaft 22 gradually increases accordingly. This is because the current flows between the U-phase and the V-phase due to the first U-phase fixed conduction setting being executed at the time t22.

Subsequently, when the angle Θ becomes larger than the rotation limit angle Θa at the time t23, the rotation angle of the rotor 51 gradually decreases, and the angle Θ of the wiper output shaft 22 gradually decreases accordingly. This is because the current flows between the U-phase and the W-phase due to the second U-phase fixed conduction setting being performed at the time t13.

Similarly, the first U-phase fixed conduction UE1 and the second U-phase fixed conduction UE2 are alternately repeated by executing the first U-phase fixed conduction setting at the times t24, t26, t28 and the second U-phase fixed conduction setting at the times t25, t27. The first U-phase fixed conduction continues the electrical conduction between the U-phase and the V-phase. The second U-phase fixed conduction continues the electrical conduction between the U-phase and the W-phase. Even when the motor 21 is electrically conducted, the change in the angle of the wiper output shaft 22 can be kept below the rotation limit angle Θa.

The wiper controller 1 configured as described above includes the driver 12, the controller 11, and the voltage detector 13. The driver 12 supplies three-phase alternating current to the motor 21, and includes a three-phase bridge circuit with the switching elements 41, 42, 43, each arranged between the terminals TU, TV, TW of the motor 21 and the positive electrode of battery 3, and the switching elements 44, 45, 46, each arranged between the terminals TU, TV, TW and the negative electrode of the battery 3.

In a case where the detection voltage value Vd exceeds the preset overvoltage determination value J1, the controller 11 controls the power supply to the motor 21 by fixing the switching element 41 to the on-state and then sequentially switching the on and off-states of the switching elements 45, 46 so that either one of switching elements 45, 46 is in the on-state.

The wiper controller 1 can allow the overcurrent caused by the surge to flow through the motor 21 by alternately repeating the forward rotation and reverse rotation of the motor 21, in a case where the surge occurs and then the voltage value of the battery 3 exceeds the overvoltage determination value J1. As a result, the wiper controller 1 can inhibit a situation in which a voltage exceeding the element breakdown voltage is applied to the elements of the circuit included in the wiper controller 1 when a surge occurs, and the wiper controller 1 can inhibit a damage to the circuit included in the wiper controller 1. Therefore, it is possible to enhance the reliability to the surge. The wiper controller 1 can limit the movement range of the wiper blade 23 to the necessary minimum by alternately repeating the forward rotation and reverse rotation of the motor 21 when the surge occurs. Therefore, it is possible to inhibit the situation in which the operation of the wiper blade 23 suddenly starts and blocks a driver's field of view during the running of the vehicle.

In the above-mentioned embodiment, each of the switching elements 41, 42, 43 corresponds to a high-side switching element, and each of the switching elements 44, 45, 46 corresponds to a low-side switching element.

S110 to S210 correspond to a process executed by a fixing electrical conductor. The switching element 41 corresponds to a target high-side switching element. The switching element 45 corresponds to a first target low-side switching element. The switching element 46 corresponds to a second target low-side switching element.

### THIRD EMBODIMENT

The following describes a third embodiment of the present disclosure with reference to the drawings. Note that in the third embodiment, portions different from the second embodiment will be described. Common configurations are denoted by the same reference numerals.

The wiper controller 1 according to the third embodiment is different from the wiper controller 1 according to the second embodiment such that the surge handing process is modified in the third embodiment. The surge handling process according to the third embodiment is different from the second embodiment, such that the surge handing process according to the third embodiment executes S175 instead of S170.

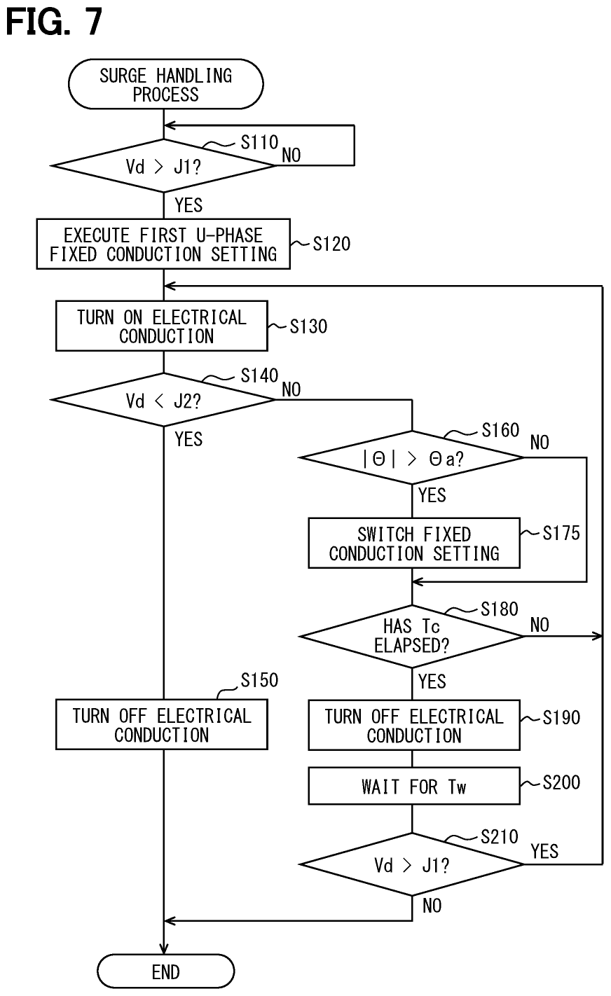

As shown in FIG. 7, if the absolute value of the angle Θ exceeds the rotation limit angle Θa at S160, the CPU 31 switches the fixed conduction setting at S175, and shifts the process to S180.

When the present fixed conduction setting is the first U-phase fixed conduction setting, the CPU 31 executes the second U-phase fixed conduction setting. When the present fixed conduction setting is the second U-phase fixed conduction setting, the CPU 31 executes the first V-phase fixed conduction setting.

When the present fixed conduction setting is the first V-phase fixed conduction setting, the CPU 31 executes the second V-phase fixed conduction setting. When the present fixed conduction setting is the second V-phase fixed conduction setting, the CPU 31 executes the first W-phase fixed conduction setting.

When the present fixed conduction setting is the first W-phase fixed conduction setting, the CPU 31 executes the second W-phase fixed conduction setting. When the present fixed conduction setting is the second W-phase fixed conduction setting, the CPU 31 executes the first U-phase fixed conduction setting.

In the first V-phase fixed conduction setting, the switching elements 42, 44 are turned to the on-state, and the switching elements 41, 43, 45, 46 are turned to the off-state. In the second V-phase fixed conduction setting, the switching elements 42, 46 are turned to the on-state, and the switching elements 41, 43, 44, 45 are turned to the off-state.

In the first W-phase fixed conduction setting, the switching elements 43, 44 are turned to the on-state, and the switching elements 41, 42, 45, 46 are turned to the off-state. In the second W-phase fixed conduction setting, the switching elements 43, 45 are turned to the on-state, and the switching elements 41, 42, 44, 46 are turned to the off-state.

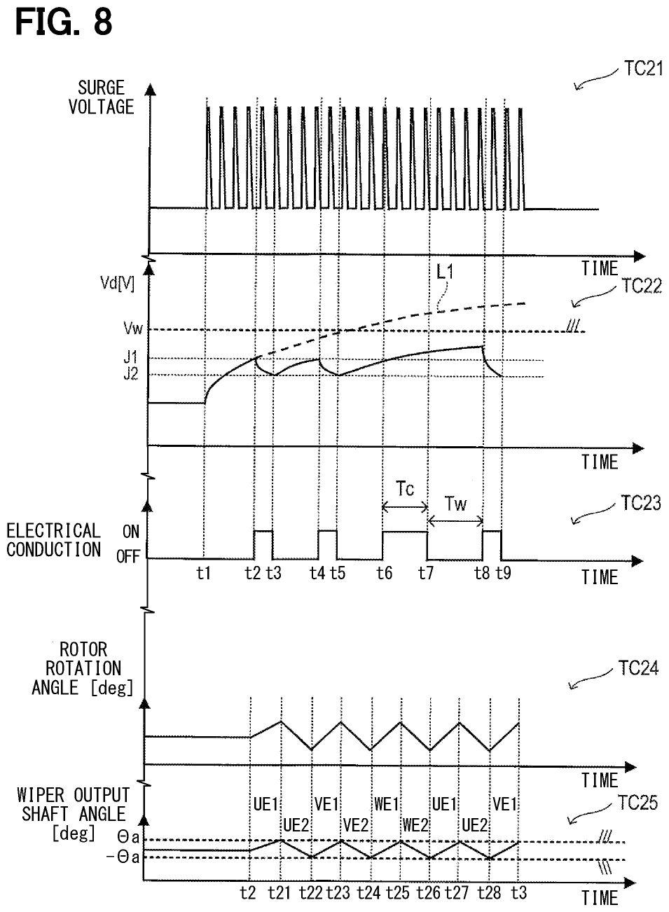

The following describes the control of the motor 21 through the controller 11. A timing chart TC21 in FIG. 8 shows a change in a surge voltage over time. A timing chart TC22 shows a change in the detection voltage value Vd over time. A timing chart TC23 shows a change in turning on or off the electrical conduction of the motor 21 over time. A timing chart TC24 shows a change in the rotation angle of the rotor 51 over time. A timing chart TC25 shows a change in the angle of the wiper output shaft 22 over time.

The timing charts TC21, TC22, and TC23 are the same as the timing charts TC1, TC2, and TC3, respectively. Therefore, the description of the timing charts TC21, TC22, and TC23 will be omitted.

The timing chart TC24 shows a change in the rotation angle of the rotor 51 over time from the time t2 to the time t3 during which the electrical conduction of the motor 21 is executed. The timing chart TC25 shows a change in the angle of the wiper output shaft 22 over time from time t2 to time t3.

As shown in FIG. 8, from time t2 when the electrical conduction of the motor 21 is started, the rotation angle of the rotor 51 gradually increases, and the angle Θ of the wiper output shaft 22 gradually increases accordingly. This is because the current flows between the U-phase and the V-phase due to the first U-phase fixed conduction setting being executed.

Subsequently, when the angle Θ becomes larger than the rotation limit angle Θa at the time t21, the rotation angle of the rotor 51 gradually decreases, and the angle Θ of the wiper output shaft 22 gradually decreases accordingly. This is because the current flows between the U-phase and the W-phase due to the second U-phase fixed conduction setting being executed at the time t21.

Subsequently, when the angle Θ becomes smaller than the rotation limit angle Θa at the time t22, the rotation angle of the rotor 51 gradually increases, and the angle Θ of the wiper output shaft 22 gradually increases accordingly. This is because the current flows between the V-phase and the W-phase due to the first V-phase fixed conduction setting being executed at the time t22.

Subsequently, when the angle Θ becomes larger than the rotation limit angle Θa at the time t23, the rotation angle of the rotor 51 gradually decreases, and the angle Θ of the wiper output shaft 22 gradually decreases accordingly. This is because current flows between the V-phase and the W-phase due to the second V-phase fixed conduction setting being performed at the time t23.

Subsequently, when the angle Θ becomes smaller than the rotation limit angle Θa at the time t24, the rotation angle of the rotor 51 gradually increases, and the angle Θ of the wiper output shaft 22 gradually increases accordingly. This is because the current flows between the W-phase and the U-phase due to the first W-phase fixed conduction setting being executed at the time t24.

Subsequently, when the angle Θ becomes larger than the rotation limit angle Θa at the time t25, the rotation angle of the rotor 51 gradually decreases, and the angle Θ of the wiper output shaft 22 gradually decreases accordingly. This is because current flows between the W-phase and the V-phase due to the second W-phase fixed conduction setting being executed at the time t25.

Subsequently, when the angle Θ becomes smaller than the rotation limit angle Θa at the time t26, the rotation angle of the rotor 51 gradually increases, and the angle Θ of the wiper output shaft 22 gradually increases accordingly. This is because the current flows between the U-phase and the V-phase due to the first U-phase fixed conduction setting being executed at the time t26.

Subsequently, when the angle Θ becomes larger than the rotation limit angle Θa at the time t27, the rotation angle of the rotor 51 gradually decreases, and the angle Θ of the wiper output shaft 22 gradually decreases accordingly. This is because current flows between the U-phase and the W-phase due to the second U-phase fixed conduction setting being performed at the time t27.

Subsequently, when the angle Θ becomes smaller than the rotation limit angle Θa at the time t28, the rotation angle of the rotor 51 gradually increases, and the angle Θ of the wiper output shaft 22 gradually increases accordingly. This is because the current flows between the V-phase and the W-phase due to the first V-phase fixed conduction setting being executed at the time t28.

By switching the electrical conduction of the motor 21 in the following order: the first U-phase fixed conduction UE1→the second U-phase fixed conduction UE2→the first V-phase conduction VE1→the second V-phase fixed conduction VE2→the first W-phase fixed conduction WE1→the second W-phase fixed conduction WE2→the first U-phase fixed conduction UE1 (and so on), it is possible to limit a change in the angle of the wiper output shaft 22 to the rotation limit angle Θa or less.

The wiper controller 1 as described above sequentially switches the high-side switches to the on-state on during fixed electrical conduction. As a result, the wiper controller 1 can further enhance reliability against the surge by suppressing the heating of the switching elements 41 to 46 caused by the current continuously flowing through one high-side switch.

In the above-mentioned embodiment, S110 to S160, S175, S180 to S210 correspond to a process executed by a fixing electrical conductor. Although one embodiment of the present disclosure has been described above, the present disclosure is not limited to the above embodiment, and various modifications can be made.

The controller 11 and the techniques thereof according to the present disclosure may be implemented by one or more special-purposed computers. Such a special-purposed computer may be provided by configuring a processor and a memory programmed to execute one or more functions embodied by a computer program. Alternatively, the controller 11 and the method thereof described in the present disclosure may be implemented by a dedicated computer provided by configuring a processor with one or more dedicated hardware logic circuits. Alternatively, the controller 11 and the method thereof described in the present disclosure may be implemented by one or more dedicated computers configured by a combination of a processor and a memory programmed to perform one or a plurality of functions and a processor configured with one or more hardware logic circuits. Further, the computer program may be stored in a computer-readable non-transitory tangible storage medium as instructions to be executed by a computer. The technique for realizing the functions of each unit included in the controller 11 does not necessarily need to include software, and all the functions may be realized using one or a plurality of hardware circuits.

Multiple functions belonging to one configuration element in the above-described embodiment may be implemented by multiple configuration elements, or one function belonging to one configuration element may be implemented by multiple configuration elements. Multiple functions belonging to multiple configuration elements may be implemented by one configuration element, or one function implemented by multiple configuration elements may be implemented by one configuration element. A part of the configuration of the above embodiment may be omitted. At least a part of the configuration of the above embodiment may be added to or replaced with another configuration of the above embodiment.

The present disclosure can be realized in various forms, in addition to the wiper controller 1 described above, such as a system including the wiper controller 1 as a component, a program for causing a computer to function as the wiper controller 1, a non-transitory tangible storage medium such as a semiconductor memory storing the program, or a control method of a wiper.

What is claimed is:

1. A wiper controller configured to control a wiper including a motor for driving a wiper blade, the wiper controller comprising:
a driver including a three-phase bridge circuit having a plurality of switching elements connecting a positive electrode and a negative electrode of a direct current power supply to a plurality of terminals of the motor, the driver configured to supply a three-phase alternating current to the motor through the three-phase bridge circuit;
a controller configured to control the motor by switching the plurality of switching elements in the driver between an on-state and an off-state;
a voltage detector configured to detect a voltage value of the direct current power supply as a detection voltage value,
wherein the controller includes a q-axis current conductor configured to control electrical conduction of the motor through vector control by switching the plurality of switching elements between the on-state and the off-state to limit a value of a q-axis current of the motor to zero, in response to that the detection voltage value exceeds a preset overvoltage determination value.

2. The wiper controller according to claim 1,
wherein the q-axis current conductor configured to stop the electrical conduction of the motor in a case where a preset duration has elapsed from beginning of the electrical conduction of the motor.

3. A wiper controller configured to control a wiper including a motor for driving a wiper blade, the wiper controller comprising:
a driver including a three-phase bridge circuit having a plurality of high-side switching elements and a plurality of low-side switching elements, the plurality of high-side switching elements connected between a positive electrode of a direct current power supply and a plurality of terminals of the motor, the plurality of low-side switching elements connected between a negative electrode of the direct current power supply and the plurality of terminals of the motor, the driver configured to supply a three-phase alternating current to the motor through the three-phase bridge circuit;
a controller configured to control the motor by switching the plurality of high-side switching elements and the plurality of low-side switching elements between an on-state and an off-state; and
a voltage detector configured to detect a voltage value of the direct current power supply as a detection voltage value,
wherein the controller includes a fixing electrical conductor configured to:
set one of the plurality of high-side switching elements as a target high-side switching element being connected to one of the plurality of terminals of the motor;
set two of the plurality of low-side switching element as a first target low-side switching element and a second target low-side switching element, both of which are connected to other two of the plurality of terminals of the motor, respectively; and
control electrical conduction of the motor by
fixing the target high-side switching element to the on-state in response to the detection voltage value exceeding a preset overvoltage determination value, and then
switching the first target low-side switching element and the second target low-side switching element between the on-state and the off-state to alternatively turn either one of the first target low-side switching element and the second target low-side switching element to the on-state.

4. The wiper controller according to claim 3,
wherein the fixing electrical conductor is further configured to sequentially change the target high-side switching element among the plurality of high-side switching elements.
